(19) United States
(12) Patent Application Publication
(10) Pub. No.: US 2012/0312159 A1
(43) Pub. Date: Dec. 13, 2012

(54) MACHINE COMPONENT WITH A CAVITATION RESISTANT COVERING

(75) Inventors: Tianjun Liu, Edwards, IL (US); Marvin Grendel McKimpson, Germantown Hills, IL (US)

(73) Assignee: Caterpillar Inc.

(21) Appl. No.: 13/158,337

(22) Filed: Jun. 10, 2011

(51) Int. Cl. F16J 10/04; B32B 15/00; C21D 6/00; F16J 10/00

(52) U.S. Cl. 92/169.1; 428/615; 148/548

(57) ABSTRACT

A machine component includes a body made of cast iron. The body may include a surface configured to be subject to cavitation-induced erosion. The component may also include a hardened covering on the surface of the body. The covering may have a crystal structure including martensite and between about 5% to about 40% austenite.

### TECHNICAL FIELD

The present disclosure relates generally to a cavitation resistant covering, and more particularly, to a cylinder liner of an engine with a cavitation resistant covering.

### BACKGROUND

Cavitation is material damage caused by the formation and collapse of bubbles, in a liquid. The cavities typically arise from rapid changes in pressure due to vibrations or turbulent flow. During cavitation (sometimes also called cavitation-erosion), the implosion of the bubbles formed in the liquid on the component surface erodes the surface. Cavitation is a source of concern in machine parts that are subject to vibratory forces while in contact with a liquid. Different materials offer different levels of resistance to cavitation. Cast iron is a material known to have relatively low resistance to cavitation. Examples of cast iron machine components that are susceptible to cavitation include, among others, housings of pumps and liners of engine cylinders.

A cylinder liner (referred to herein as a “liner”) is a removable cylindrical part fitted into an engine block of an internal combustion engine to form a cylinder. Typically, liners are made of steel or cast iron. Steels and cast irons are both iron alloys having primarily iron and carbon as the main alloying elements. Steels contain less than 2% (usually less than 1%) carbon, while cast irons typically contain more than 2% carbon. Pistons reciprocate within the cylinder to generate mechanical power. An inside surface of the liner, that serves as a sliding surface for the piston, bounds the combustion chamber of the cylinder. During operation of the engine, the liners get heated due to the combustion of fuel in the combustion chamber. To cool the liner, a liquid coolant (such as, water) is often circulated through a cooling jacket extending about a portion of the outer surface of the liner. Typically, the outer surface of the liner is in direct contact with the coolant circulating through the cooling jacket. It is known that the region of the liner in contact with the coolant experiences erosion from cavitation. To reduce cavitation-induced erosion, the outer surface of the liner may be coated, or treated, to increase its resistance to cavitation.

U.S. Pat. No. 7,617,805 (the '805 patent) discloses a method of heat treating the outer surface of the liner to provide a hardened layer of purely martensitic microstructure to inhibit cavitation-induced erosion. While the layer of purely martensitic microstructure of the '805 patent may provide some protection from cavitation induced erosion, the amount of protection provided may not be sufficient in some applications.

The present disclosure is directed to overcoming these or other limitations in existing technology.

### SUMMARY

In one aspect, a machine component is disclosed. The component includes a body made of cast iron. The body may include a surface configured to be subject to cavitation-induced erosion. The component may also include a hardened covering on the surface of the body. The covering may have a crystal structure including martensite and between about 5% to about 40% austenite.

In another aspect, a method of making a machine component that is configured to operate in communication with a liquid is disclosed. The method includes fabricating a body from cast iron. The body may include a surface that is configured to be subject to cavitation-induced erosion from the liquid. The method may also include forming a hardened covering on the surface of the body. The covering may have a crystal structure including martensite and between about 5% to about 40% austenite.

In yet another aspect, an engine is disclosed. The engine includes an engine block including one or more cylinder bores. The engine may also include a cylinder liner positioned in at least one of the one or more cylinder bores. The cylinder liner may include a hollow cylindrical sleeve with an inner surface and an outer surface extending from a first end to a second end along a longitudinal axis. The engine may also include a covering on the outer surface of the sleeve. The covering may be a surface layer of the outer surface where the crystal structure includes martensite and between about 5% to about 40% austenite.

### BRIEF DESCRIPTION OF THE DRAWINGS

FIG. 1 is a cross-sectional view of part of an engine with a cylinder liner;

FIG. 2 is a flow chart illustrating an exemplary method of making a cavitation resistant covering of the cylinder liner of FIG. 1; and

FIG. 3 is a flow chart illustrating another exemplary method of making a cavitation resistant covering of the cylinder liner of FIG. 1.

### DETAILED DESCRIPTION

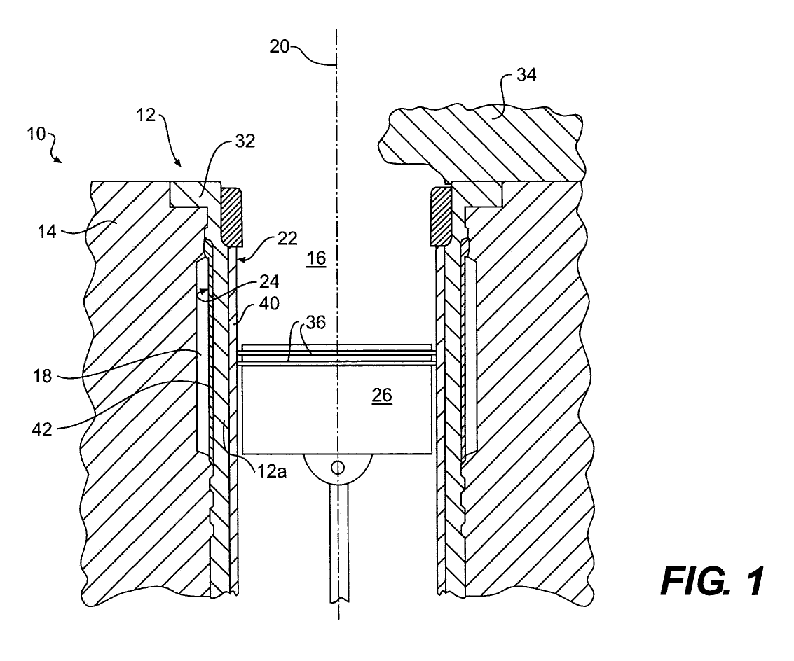

FIG. 1 is a cross-sectional view of part of an engine 10 with a cylinder liner 12 (“liner 12”). Engine 10 includes an engine block 14 comprising a piston bore 16. Liner 12 may be removably mounted in the piston bore 16. Liner 12 has a hollow generally cylindrical body extending along a longitudinal axis 20 with an inner surface 22 and an outer surface 24. The liner 12 may be securely retained in piston bore 16 in any manner. In the embodiment illustrated in FIG. 1, an annular flange 32 extending radially from a top end of the liner 12 mates with an annular step-like mounting surface of the engine block 14 to retain the liner 12 in the piston bore 16. However, this method of retaining the liner 12 is only exemplary, and liner 12 can be retained on the engine block 14 by any other methods. For instance, in some embodiments, liner 12 may be press-fitted or interference fitted on bore 16. In these embodiments, liner 12 may not include a flange 32. A cylinder head 34, secured to the engine block 14, forms a combustion chamber of the engine 10 within the bore 16. The combustion chamber is bounded on the sides by the inner surface 22 of the liner 12.

During operation of the engine 10, combustion that occurs in the combustion chamber heats the liner 12. Engine block 14 may include a cooling jacket 18, which circulates a coolant (for example, water) along the outer surface 24, to cool the liner 12. Although FIG. 1 illustrates a single annular cooling jacket 18 around the liner 12, as is known in the art, other configurations are possible. For example, in some embodiments, multiple discrete or connected cooling jackets 18 may extend along portions of the liner 12. The current disclosure is applicable to all possible configurations of cooling jackets 18. The surface of the liner 12 in contact with the coolant in cooling jacket 18 is susceptible to cavitation.

Liner 12 may be made of various iron alloys, including cast iron and steel. In some embodiments, liner 12 is an iron alloy containing greater than, or equal to, 50% of pearlite in its matrix. An iron alloy having greater than, or equal to, 50% of pearlite in its matrix is referred to herein as a pearlitic material. Pearlite is a two-phased, layered structure of alpha-ferrite and cementite. The pearlite may be present in the as-cast state of the iron alloy or may be produced by subsequent heat treatment. The pearlitic material may include several varieties of steel and cast iron. A pearlitic cast iron may include graphite in the form of flakes, compacted flakes, or nodular graphite depending on chemistry and cooling rate. Cast iron that contains flake graphite, compacted graphite, and nodular graphite are referred to as gray cast iron, compacted graphite iron (CGI), and ductile iron, respectively.

As is known in the art, a piston 26 reciprocates in the piston bore 16 of engine 10. As the piston 26 reciprocates, piston rings 36 (of piston 26) slide on the inner surface 22 of the liner 12. Due to the reciprocation of the piston 26, vibrations may be induced in the liner 12, and the inner surface 22 may be subjected to abrasive wear. To improve the wear resistance of the inner surface 22, a hardened shell, or case 40, is formed on the inner surface 22. Case 40 is a region of the inner surface 22 in which the matrix microstructure of the cast iron material is transformed to be substantially martensitic by, for example, heat treatment.

To form case 40, the inner surface 22 of the liner 12 is heated to a high temperature and then cooled rapidly (or quenched) to create a “case” of martensite on the surface. Any known surface heat treatment method may be used to heat treat the surface regions of the inner surface 22. For example, methods that employ direct application of a flame (such as, torch hardening) or methods such as induction heating or laser hardening may be applied to heat treat the inner surface 22. As is known in the art, when an iron alloy is heated to a temperature in the austenitic range and held at this temperature for a sufficient time, the crystal structure of the iron alloy changes to an austenite structure. When a cast iron alloy is held at this temperature, a portion of the carbon contained in the alloy dissolves and flows into the austenite. When the alloy is then quenched, the carbon atoms have insufficient time to diffuse out of the austenite, so that the iron-base matrix transforms to martensite. Transformation of austenite to martensite begins at the martensite start temperature. When the alloy cools further and reaches the martensite finish temperature, most of the austenite will have transformed into martensite. Thus, after quenching, a case 40 having a substantially martenisitic microstructure will be formed on inner surface 22. Typically, the residual amount of retained austenite in the substantially martensitic case 40 may be less than or equal to about 1%. Martensite is hard and wear resistant. Therefore, case 40 provides wear resistance to the inner surface 22. Case 40 may have a constant thickness, or different thicknesses, along the length of liner 12. In some embodiments, the thickness of case 40 at different regions may be selected to increase wear life while minimizing undesirable side effects.

During operation of engine 10, vibrations induced in the liner 12 (as a result of normal engine operation) result in the formation of vapor bubbles in the coolant. These bubbles may implode against an outer surface 24 of the liner 12. The implosion of these bubbles causes cavitation damage (or pitting) on the outer surface 24 of the liner 12 that is in contact with the coolant in coolant jacket 18. To protect the outer surface 24 from cavitation damage, a cavitation resistant covering 42 (hereinafter “covering 42”) may be applied to the outer surface 24. Covering 42 is a layer of material on outer surface 24 in which the crystal structure of the material is martensite with between about 5%-40% of austenite. The covering 42 may extend substantially along an entire length of the liner 12, or may only extend along selected portions of the length of the liner 12. In some embodiments, the covering 42 may cover the outer surface 24 of the liner 12 that is exposed to the coolant in coolant jacket 18. In some embodiments, covering 42 may extend circumferentially around liner 12 over substantially all portions of the liner 12 that forms a boundary wall of the coolant jacket 18. Although in general, the covering 42 may have a crystal structure of martensite with between about 5%-40% of austenite, in some embodiments, the amount of austenite may be between about 10%-30%. In some embodiments, the covering 42 may have a crystal structure of martensite with between about 20%-30% austenite.

The covering 42 may be formed on outer surface 24 in any manner. In some embodiments, the material on the surface layer of the outer surface 24 may be transformed (for example, by surface heat treatment) to form the covering 42. In other embodiments, a layer of material separate from the material of the liner 12 may be attached to the liner 12 to form the covering 42. In some embodiments, liner 12 may be a two layer liner formed by, for example, a process such as centrifugal casting. It is also contemplated that in some embodiments, in place of a separate covering 42, the covering 42 may be made of a material of the liner 12 (entire thickness of the liner is made of the covering material). In embodiments where the surface layer of outer surface 24 is transformed to form covering 42, a surface heat treatment, or a surface hardening, process may be applied to the outer surface 24 of the liner 12 to form the covering 42. Any known surface hardening process, such as, laser hardening, flame hardening, induction hardening, etc. may be applied to the outer surface 24 to selectively harden the surface layer of the outer surface 24 and form covering 42. In some embodiments, the same or a similar surface heat treatment process that is used to create case 40 may be applied to the outer surface 24 to form covering 42. The heat treatment process used to form covering 42 will be configured to produce a microstructure that is martensite with between about 5%-40% of austenite.

To form covering 42, the outer surface 24 is heated to a temperature in the austenitic range (from about 800° C. to about 1100° C.) and quenched. As explained with reference to the formation of case 40, when the outer surface 24 of an iron-based liner is heated to a temperature in the austenitic range, the crystal structure of the alloy in the outer surface 24 changes to an austenite structure. And, during quenching, this austenitic microstructure is transformed to martensitic. However, if the amount of carbon in the austenite is high, the amount of residual austenite in the microstructure of the cooled alloy will be relatively large. The heat treatment process used to form covering 42 is tailored to produce between about 5-40% of retained austenite in the covering 42 after quenching. Since the heat treatment parameters that may be varied to control the amount of retained austenite after quenching are known in the art, they not extensively discussed herein. In some embodiments, the amount of retained austenite in covering 42 after quenching may be increased by increasing the temperature to which the outer surface 24 is heated during heat treatment and/or by increasing the soak time at this temperature.

Although any surface heat treatment process may be used to form covering 42, in some embodiments, an induction heat treatment process may be used to transform a layer of material on the outer surface 24 to covering 42. During this process, an induction coil scans the outer surface 24 of the liner 12 and applies an alternating magnetic field on the outer surface 24. This alternating magnetic field induces a current flow that heats the outer surface 24 by Joule heating. As is known in the art, by varying parameters of the scanning (such as, frequency, power level, scan speed, etc.), the depth of covering 42 may be varied. While a thick covering 42 may seem desirable from a cavitation life point of view, it may have undesirable side effects. For instance, increasing the thickness of the covering 42 may require increasing the thickness of the liner 12. Increasing the thickness of the liner 12 may undesirably increase the weight of the liner 12. Further, a thicker covering 42 may induce higher residual stresses on liner 12. Therefore, the thickness of the covering 42 is selected to achieve a beneficial increase in cavitation resistance while minimizing undesirable side effects.

In some embodiments, covering 42 may have a constant thickness on all areas of liner 12, while in other embodiments, the thickness of covering 42 in different regions may be different. Covering 42 of different thicknesses may be obtained by varying the parameters of the hardening process at different regions. For instance, in embodiments where an induction hardening process is used to form covering 42, a thicker covering 42 may be formed in selected regions by decreasing the frequency of the alternating magnetic field applied to this region, increasing the power level of the magnetic field applied to this region, and/or decreasing the scan speed of the induction coil in this region. Although FIG. 1 illustrates the outer surface 24 as having a distinct layer of covering 42 on a base material 12a, in some embodiments, a transition layer may be present between the base material 12a and covering 42. Further, as described previously, in some embodiments, in place of a separate covering 42, the liner 12 may be fabricated to include martensite with between about 5%-40% of retained austenite. Covering 42 with between about 5%-40% of retained austenite therein may increase the resistance of the liner 12 to cavitation induced damage.

### INDUSTRIAL APPLICABILITY

The disclosed machine component may be applied in any application where it is desired to increase the resistance of the component to cavitation-induced damage. A cavitation resistant covering is formed on a surface of the component that operates in communication with a liquid, and may therefore be subjected to cavitation-induced erosion. This cavitation resistant covering includes between about 5%-40% of retained austenite therein. The cavitation resistant covering may be formed by any method. In some embodiments, a layer of material on the surface of the component may be transformed to form the cavitation resistant covering by a heat treatment process. An exemplary method of forming a cavitation resistant covering 42 on the outer surface 24 of a cylinder liner is described below.

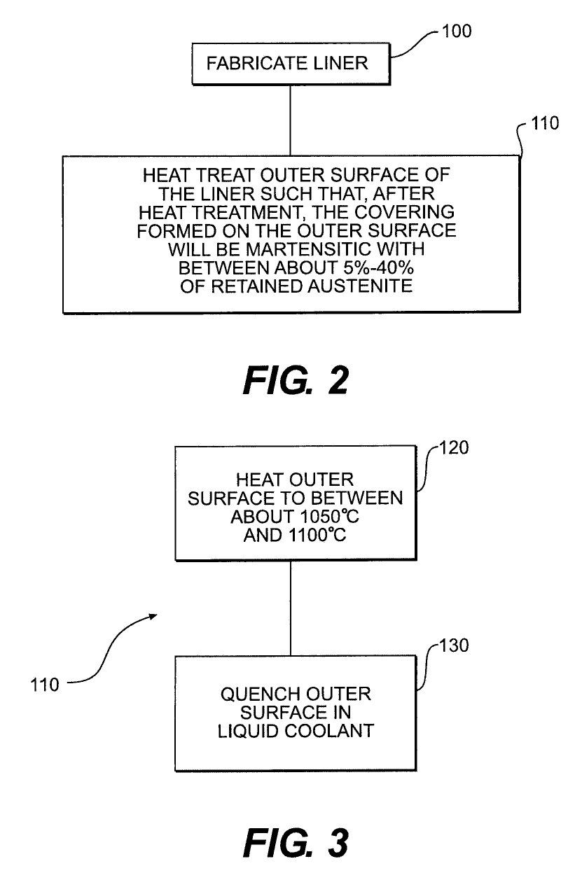

FIG. 2 discloses an exemplary method of producing a gray iron cylinder liner 12 with a cavitation resistant covering 42. The liner 12 may be fabricated by any known process (step 100). In some embodiments, in place of fabricating a new liner 12, a previously used liner may be refurbished and used. In these embodiments, a liner 12 that was previously used in an engine 10 may be cleaned, and its outer surface 24 prepared for applying a covering 42 thereon. Preparation of the outer surface 24 may involve degreasing and removal of remnants, if any, of a previous covering from the outer surface 24. A heat treatment process is then performed to form a covering 42 on the outer surface 24 of the liner 12. The applied heat treatment process may be configured to create a covering 42 that is martensitic with between about 5%-40% of retained austenite (step 110). As illustrated in FIG. 3, in one exemplary embodiment, the heat treatment process (that is, step 110) may include heating a layer of material on the outer surface 24 to a temperature between about 1050° C. and 1100° C. (step 120). It should be noted that the temperature to which the outer surface 24 is heated will depend on the composition of the alloy used to fabricate liner 12. Typically, the outer surface may be heated toward the higher end of the austenitic temperature range of the material used to fabricate the liner 12 to retain a sufficient amount of austenite in the microstructure of the covering 42 after heat treatment. Heating the outer surface 24 to higher temperatures may increase the amount of retained austenite in the covering 42. Similarly, increasing the soak time at the high temperature may also increase the amount of retained austenite in the covering 42. After a few seconds at the high temperature, the liner 12 is quenched in a fluid coolant (step 130) at a rate sufficient to produce martensite. Any suitable fluid coolant (such as, water, polymer, oil, etc.) may be used to quench the outer surface 24. The liner 12 may be quenched to room temperature, or to a temperature higher than room temperature and then air cooled to room temperature. Due to heat treatment, a layer of material on the outer surface 24 of the liner 12 will be transformed to a martensitic microstructure with between about 5%-40% of retained austenite. After quenching, the covering 42 formed on the liner 12 that was heated to between about 1050° C. and 1100° C. (in step 120) includes martensite with about 30% of retained austenite therein. The amount or retained austenite in the covering 42 may be measured using X-ray diffraction or other suitable measurement technique. Since techniques to measure the amount of retained austenite in covering 42 are known in the art, they are not discussed herein.

Although the inventive aspects of the current disclosure are described using a cylinder liner, in general, a covering 42 including martensite with between about 5%-40% of retained austenite may be used to increase the cavitation resistance of any cast iron component having a pearlitic microstructure. It will be apparent to those skilled in the art that various modifications and variations can be made to the disclosed machine component. Other embodiments will be apparent to those skilled in the art from consideration of the specification and practice of the disclosed machine component. It is intended that the specification and examples be considered as exemplary only, with a true scope being indicated by the following claims and their equivalents.

What is claimed is:

1. A machine component, comprising:
a body made of cast iron, the body including a surface configured to be subject to cavitation-induced erosion; and
a hardened covering on the surface of the body, the covering having a crystal structure including martensite and between about 5% to about 40% austenite.

2. The component of claim 1, wherein the covering is a layer of the surface that is transformed by a heat treatment process.

3. The component of claim 1, wherein the component is a cylinder liner, and the surface is an outer surface of the liner that is configured to operate in communication with a liquid coolant.

4. The component of claim 1, wherein the covering has a crystal structure including martensite and between about 10% to about 30% austenite.

5. The component of claim 1, wherein the body is made of gray cast iron.

6. The component of claim 4, wherein the body is made of ductile iron.

7. The component of claim 1, wherein a thickness of the covering is substantially uniform throughout.

8. The component of claim 1, wherein the covering has a crystal structure including martensite with about 30% retained austenite.

9. The component of claim 1, wherein the surface is an outer surface and the component further includes an inner surface opposite the outer surface, the inner surface including a hardened case, the case being a surface layer of the inner surface having a crystal structure that is substantially martensitic.

10. A method of making a machine component that is configured to operate in communication with a liquid, comprising:
fabricating a body from cast iron, the body including a surface that is configured to be subject to cavitation-induced erosion from the liquid; and
forming a hardened covering on the surface of the body, the covering having a crystal structure including martensite and between about 5% to about 40% austenite.

11. The method of claim 10, wherein forming a covering includes applying a heat treatment process to transform the crystal structure of a layer of the surface.

12. The method of claim 11, wherein applying a heat treatment process includes heating the layer of the surface to a temperature in the austenitic range of the cast iron.

13. The method of claim 12, wherein applying a heat treatment process includes heating the layer of the surface to a temperature between about 1050° C. and about 1100° C.

14. The method of claim 12, wherein applying a heat treatment process includes quenching the layer of the surface after the heating.

15. The method of claim 11, wherein applying a heat treatment process includes applying an induction hardening process on the surface of the body.

16. The method of claim 11, wherein forming a hardened covering includes transforming the crystal structure of the layer to be martensitic with between about 5% to about 40% austenite.

17. An engine, comprising:
an engine block including one or more cylinder bores; and
a cylinder liner positioned in at least one of the one or more cylinder bores, the cylinder liner including:
a hollow cylindrical sleeve with an inner surface and an outer surface extending from a first end to a second end along a longitudinal axis; and
a covering on at least a portion of the outer surface, the covering being a surface layer of the outer surface wherein the crystal structure includes martensite and between about 5% to about 40% austenite.

18. The engine of claim 17, wherein the cylinder liner is made of cast iron.

19. The engine of claim 17, wherein the crystal structure of the surface layer is martensite with between about 10% to about 30% austenite.

20. The engine of claim 17, wherein the covering extends substantially around the outer surface along at least a portion of a length of the liner.
